(19) United States
(12) Patent Application Publication
(10) Pub. No.: US 2003/0033791 A1
(43) Pub. Date: Feb. 20, 2003

(54) Cyclonic separator for mist collectors

(76) Inventor: Michael R. Elliott, Beloit, WI (US)

Correspondence Address: KEITH FRANTZ, 401 WEST STATE STREET, SUITE 200, ROCKFORD, IL, 61101

(21) Appl. No.: 09/930,770

(22) Filed: Aug. 15, 2001

(51) Int. Cl. B01D 45/12

(52) U.S. Cl. 55/396; 55/455; 55/456

(57) ABSTRACT

A separator adapted to be placed in a mist collection system prior to the final air cleaning stage, and adapted to remove a substantial portion of the mist from the air, includes stationary vanes in a cylindrical housing to establish a cyclonic flow therethrough, an annular flow restriction collar to establish a liquid collection area at the downstream end of the housing, a drain for discharge of the liquid from the collection area, and a flow interrupter to direct the swirling liquid into the drain.

### CROSS-REFERENCES TO RELATED APPLICATIONS

none.

### REFERENCE TO MICROFICHE APPENDIX

not applicable.

### STATEMENT REGARDING FEDERALLY SPONSORED RESEARCH OR DEVELOPMENT

not applicable.

### BACKGROUND OF THE INVENTION

1. Field of Invention

The present invention relates generally to mist collectors/mist collection systems of the type suitable to remove oil mist, water vapor, synthetic coolant mist and other mist from the air surrounding commercial machining operations.

More particularly, the invention relates to a separator adapted to remove a substantial portion of such mist prior to the contaminated air reaching a final stage cleaning device in the mist collection system.

2. Description of Prior Art

Mist collectors are commonly used in commercial machining environments to remove contaminating mist from the air, particularly in an area surrounding a grinding or other machining operation.

During commercial grinding and machining operations, a liquid coolant/lubricant is often sprayed at the location of cutting engagement between a workpiece and cutting tool to provide lubrication and cooling of the tool.

Although the majority of this coolant falls to a collection center, a portion of the coolant sprays into the air in the form of relatively heavy mist. For obvious health, cleanliness and economic reasons, it is desirable to remove this mist from the air, and if suitable, return the liquid to the reservoir supplying coolant to the machine.

Numerous mist collectors are commercially available to remove this contaminating mist from the air. Some of the more common types are electrostatic mist collectors, centrifugal mist collectors, and mist collectors that use filter media. As to be expected, each type of collector has it advantages and disadvantages. However, all mist collectors require a certain level of periodic service and maintenance for proper performance.

For example, centrifugal collectors are well suited for heavy-duty environments, to collect substantial volumes of mist, but can require frequent maintenance to keep the centrifuge balanced. This maintenance typically requires trained service personnel, and can be time consuming and relatively expensive. Filter collectors are easier to service, normally requiring only cleaning or changing the filter, but in heavy-duty environments, the labor time to frequently clean and/or the filter replacement costs can be substantial. Electrostatic mist collectors are particularly useful in connection with smoky environments, but are relatively expensive to purchase, and still require periodic cleaning to maintain rated working performance.

Thus, it is apparent that there is an ever present need and desire to reduce the costs associated with periodic maintenance of these and other type mist collection systems. In particular, it is desirable that a low-maintenance, relatively low cost apparatus be provided that would remove a substantial portion of the mist from the air prior to reaching the filter, centrifuge, or other final cleaning stage apparatus.

### SUMMARY OF THE INVENTION

The general aim of the present invention is to provide a new and improved separator adapted to be placed in a mist collector of the subject type, and adapted to remove a substantial portion of the mist from the contaminated air prior to the air reaching the final air cleaning stage. As a result, the separator hereof decreases the need for and expense associated with periodic maintenance requirements of the final cleaning stage apparatus.

Another aim of the invention is to provide a separator that is reliable at removing mist from the air, yet is relatively inexpensive, does not require the use of moving or consumable parts, and does not require periodic cleaning or maintenance service.

Still another objective is to provide such an improved separator adapted for relatively low pressure drop to facilitate use in existing mist collection systems without the need to change the fans installed therein.

A detailed objective is to provide an in-line flow-through separator having coaxial inlet and exit openings, and a cylindrical tubular housing extending coaxial therebetween, the housing being preferably located radially outwardly of the inlet and outlet openings to define an expansion chamber at the upstream end thereof to achieve a relatively low pressure drop therethrough.

Another detailed objective of the invention is to provide stationary vanes in the upstream portion of the housing to establish a cyclonic flow as the contaminated air flows therethrough. This cyclonic action causes the mist to migrate outwardly and travel in the downstream direction along the inside diameter wall of the housing.

Another detailed objective is to provide an annular flow restrictor sized to establish an annular liquid collection chamber at the downstream end of the housing. The annular space between the flow restrictor and the inside diameter of the housing allows the liquid to flow into the collection area, while the flow restrictor prevents the liquid from being sucked back into the air flow as it exits the separator. In preferred embodiments, the flow restrictor diverges conically in the downstream direction to provide for a converging entrance to the collection chamber.

Still another objective is to provide a flow interrupter that projects into the collection chamber to direct the swirling liquid therein into a drain, whereupon the liquid may be either returned to the reservoir or disposed of as desired.

These and other objectives and advantages of the invention will become more apparent from the following detailed description when taken in conjunction with the accompanying drawings.

### BRIEF DESCRIPTION OF THE DRAWINGS

FIG. 1 is a diagrammatic view of a machining station equipped with a mist collection system including a separator in accordance with the present invention.

FIGS. 2-4 are side, downstream end, and upstream end views, respectively of the separator.

FIG. 5 is a cross-sectional view taken along the line 5-5 of FIG. 4.

FIGS. 6 and 7 are cross-sectional views taken along the lines 6-6 and 7-7 of FIG. 5.

FIG. 8 is a perspective of the separator, with portions of the separator housing being cut-away for clarity of showing certain internal components.

While the invention is susceptible of various modifications and alternative constructions, a certain illustrated embodiment has been shown in the drawings and will be described below in detail. It should be understood, however, that there is no intention to limit the invention to the specific form disclosed, but on the contrary, the intention is to cover all modifications, alternative constructions, and equivalents falling within the spirit and scope of the invention.

### DETAILED DESCRIPTION OF THE INVENTION

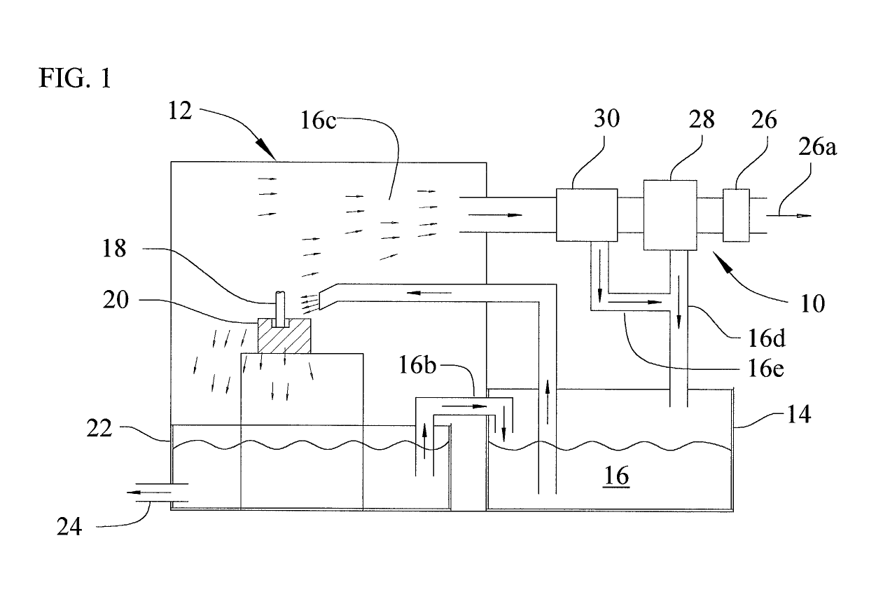

For purposes of illustration, the present invention is shown diagrammaticly in FIG. 1 in connection with a machining center 10 that uses liquid coolant during machining operations, and is provided with a mist collection system 12 for removal of coolant mist from the air surrounding the machining station.

Briefly, the machining center 10 includes a coolant reservoir 14 from which coolant 16 is sprayed as at 16a onto the cutting engagement between a cutting tool 18 and a workpiece 20, and a coolant collection/cleaning station 22 from which chips and other contaminate may be discharged as at 24 and cleaned coolant returned to the reservoir as indicated at 16b.

The mist collection system 12 includes a fan 26 that draws contaminated air as generally indicated at 16c from the area surrounding the machining station 10, and through a cleaner 28 for removal of the mist therefrom, the liquid being either returned to the reservoir as at 16d or otherwise disposed of, and the cleaned air being discharged as at 26a. The arrows in FIG. 1 indicate these general coolant and air flow patterns.

The mist collection system 12 is also provided with a separator 30 in accordance with the present invention. The separator is placed in the collection system upstream of the cleaner 28 for removal of a substantial portion of the mist prior to the air reaching the cleaner. The liquid removed by the separator is either returned to the reservoir as at 16e or otherwise disposed of.

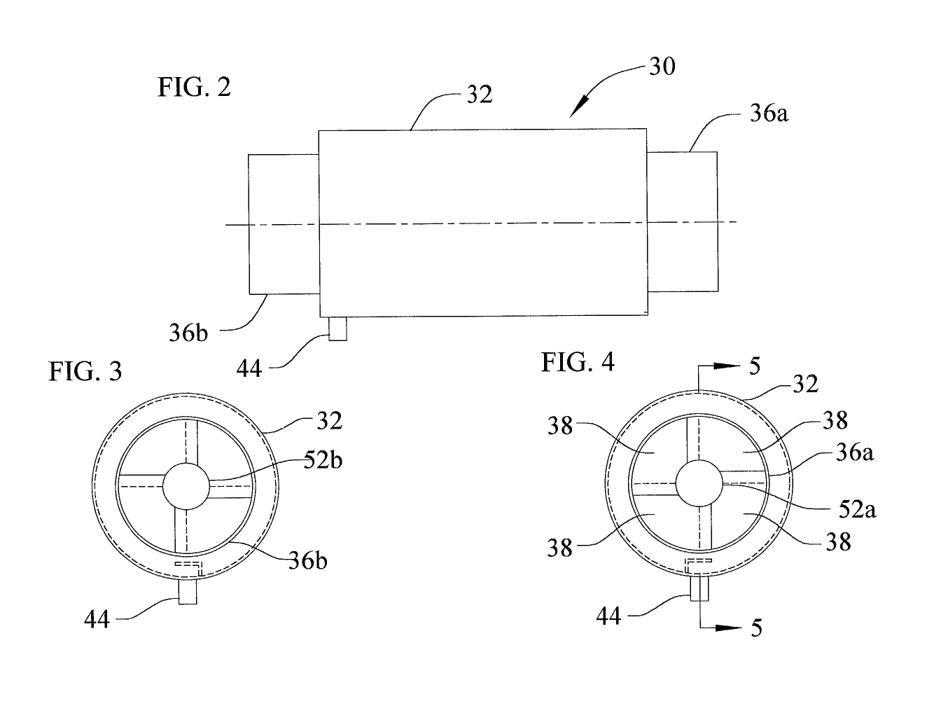

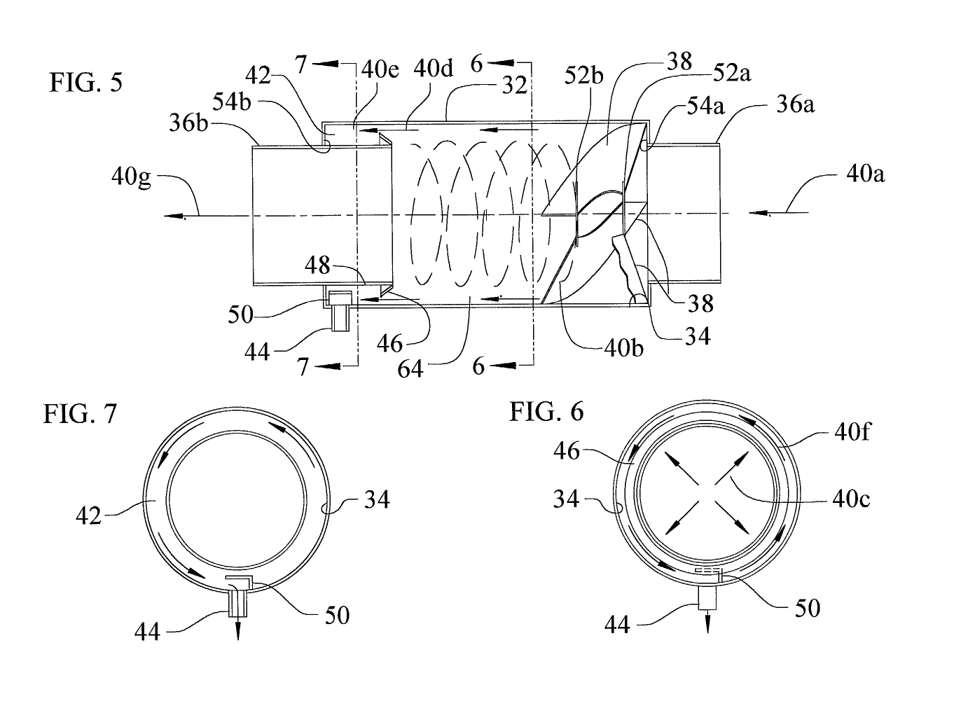

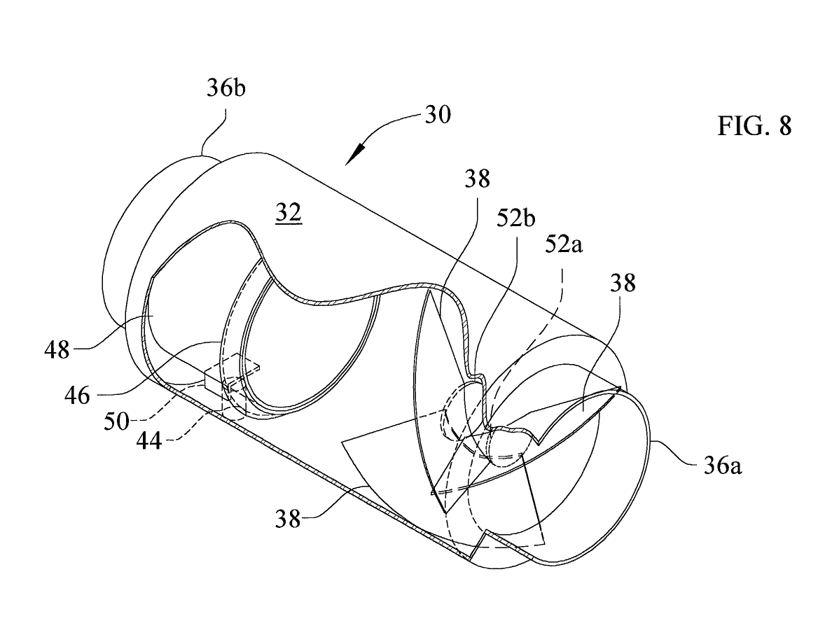

The separator 30 includes a cylindrical, tubular housing 32 (see FIGS. 2-4) that establishes a cylindrical inside wall 34 (see FIGS. 5-7), and that is connected between aligned inlet and exit end couplings 36a and 36b provided with associated inlet and exit openings and adapted for connection to the hose or piping of the mist collection system 12 such that contaminated air enters as indicated at 40a and pre-cleaned air exits as indicated at 40g. The separator may be used with all types of mist collection systems, including both new and pre-existing systems. Therefore, the end couplings will be adapted and modified as desired for the system in which it is installed.

Internal stationary vanes 38 are connected in the upstream end portion of the housing. The vanes are sized and positioned to establish a cyclonic air flow pattern such as indicated at 40b downstream thereof. The cyclonic action causes the moisture to migrate outwardly as indicated at 40c to the inside wall 34, and to flow downwardly along the surface of the inside wall 34 as indicated at 40d. To this end, a separation chamber 64 is defined downstream of the vanes, generally in the center portion of the housing, and is characterized as being of generally open, unobstructed construction as shown in FIG. 5 for maximum separation of moisture from the swirling air flowing therethrough. In preferred embodiments, the vanes are connected at both the upstream and downstream ends, between both the inside wall 34 and longitudinally spaced center supports 52a, 52b to provide for relatively stiff cyclonic-flow inducing vane structure.

A liquid collection chamber 42 is located in the downstream portion of the separator 30 to collect the liquid flowing along the inside wall 34, and to direct the liquid to a drain 44. The liquid collection chamber also establishes a barrier to prevent the liquid from being sucked back into the air as it exits the separator such that, once the liquid enters the chamber, it is generally trapped therein. The collection chamber is an annular, dead-ended space provided with an annular entrance opening that is coincident with the inside wall 34 of the housing such that liquid flowing in the downstream direction along the inside wall of the separation chamber flows directly into the collection chamber as indicated at 40d. In preferred embodiments, the collection chamber is defined between the outside diameter (OD) of an exit tube 48 that extends in the upstream direction from the exit coupling 36b, the inside diameter (ID) of the housing wall 34, a downstream end wall 54b of the housing, and a flow restrictor extending radially outwardly from the exit tube 48 and having an outer periphery spaced inwardly from the cylindrical wall 34 to define the entrance opening to the collection chamber therebetween. For separators intended to be used in a generally vertical orientation, the drain hole 44 is preferably positioned with its downstream open edge coincident with or slightly downstream of the radially outer edge of the end wall 54b (to the left as shown in FIG. 5) to preclude a dead-space behind the drain hole in which liquid could accumulate.

The flow restrictor 46 is sized to allow the liquid flowing along the wall 34 to flow into the collection area as indicated at 40d-e, but is sized to substantially restrict the annular flow area to prevent the liquid in the chamber 42 from being sucked back out by the vacuum pressure resulting from the air flow pattern restricting at the exit. The flow restrictor 46 is preferably provided in the form of a tapered cone, either with straight outer profile shown or with an outer profile that includes a slight curvature, that diverges outwardly in the downstream direction to provide for a converging entrance leading into the collection chamber, and that is connected to the upstream end of the exit cylinder 48, which in this instance, is an extension of the downstream end coupling 36b. Alternate connection of the flow restrictor and construction of the annular liquid collection chamber in accordance herewith will be will be apparent to those skilled in the art.

In the collection chamber 42, the liquid continues to flow in a generally circular pattern such as indicated at 40f in FIG. 6. Upon reaching the downstream end and bottom of the chamber, circulation of the liquid is interrupted by a flow-interrupter 50 that projects into the collection chamber in the downstream end portion proximate the downstream wall 54b and is shaped to direct the liquid flowing therein to the drain 44, preferably provided in the form of a generally radially inwardly extending wall portion that breaks the swirling flow at the drain. To this end, the flow interrupter is preferably connected or located just downstream of the drain with respect to the swirling flow of liquid therein, and is provided in a form that includes at least a first portion that projects generally radially inwardly from and extends generally longitudinally along the wall 34. In preferred embodiments, the flow interrupter is further provided with a second portion that extends generally substantially circumferentially from the first portion such as the L-shaped hood shown that extends over and above the drain hole, or in the form of a curved-hood that curves over and above the drain hole. It has been found that, in most instances encountered, the hood extending to a position over the drain hole is preferred as providing better direction of the liquid into the drain as compared with, for example, a straight interrupter consisting of only the first generally radially projecting portion.

For use in existing mist collection systems, the separator 30 is preferably adapted for relatively low air pressure drop. This allows use of the separator to be used within the air-flow capacity of the fan of the existing system. To this end, in preferred embodiments, the separator is provided with upstream and downstream annular walls 54a, 54b that extend radially outwardly from associated inlet and exit couplings 36a, 36b proximate the inlet and exit openings, and the inside wall 34 extends therebetween to define an upstream expansion chamber into which the air flow enters upon flowing through the inlet opening and in which the stationary vanes are located, the inside diameter of the wall 34 being preferably approximately one-fourth to one-third larger than the diameter of the hoses and end couplings 36a, 36b (i.e., the diameter of the inlet and exit openings) for a relatively low pressure drop embodiment.

By way of dimensional example, one of the common size hoses currently used in mist collectors are six inch hoses. In this instance, it has been found that a cylindrical wall ID of eight inches, with end coupling of six inches diameter, provides relatively low pressure drop; and that four vanes extending longitudinally approximately four and one-half (4-½) inches, with the leading edges set at an angle of approximately 25 degrees with respect to the upstream opening face (as seen in FIG. 5), and extending longitudinally therefrom at an angle of approximately 35 degrees, provides good cyclonic action in the separator.

It has also been found that a flow restrictor adapted to provide a radial clearance of approximately one-fourth (¼) to one-half (½) inch, and preferably three-eighths (⅜) inch allows the liquid to enter the collection chamber 42, while providing good restriction to prevent the liquid from leaving the chamber. In this example, as well as other similarly sized units such as for eight inch hoses provided with a ten inch ID wall and a flow restrictor cone radial clearance of approximately three-eighths inch, removal of between 85-95% of the mist from the air has been consistently achieved, with a relatively low pressure drop.

It will also be understood, however, that for new design systems where the pressure drop may be permitted to rise, because the capacity of the fan has not yet been established (as compared to existing mist collections systems with an already installed fan), the dimensional difference between the end couplings and the inside diameter of the housing may be reduced.

It has also been found that the optimum size and number of vanes to establish the desired cyclonic action will vary depending on the size of the cylindrical wall 34. Continuing with the above dimensional examples, it has been found that three vanes of suitable size provide good cyclonic action in a separator with a six inch ID, and five vanes may be required in the larger ten inch housing.

From the foregoing, it will be apparent that the present invention brings to the art a new and improved mist separator which, by virtue of the unique liquid collection chamber at the downstream end of the housing, a flow restriction provided at the inlet of the chamber, and a flow interrupter positioned in the circular flow path of the liquid in the collection chamber, the separator is uniquely adapted to remove a substantial portion of mist in the air prior to the final cleaning stage device. As a result, the work-load of the cleaning device is substantially reduced, resulting in reduction in periodic maintenance costs.

I claim:

1. A separator for a mist collection system comprising:
a) a cylindrical tube provided with inlet and exit openings to allow air to be drawn therethrough,
b) a set of stationary vanes connected in the upstream portion of the tube and sized and positioned to direct the air flowing therethrough in a cyclonic path through the tube such that mist in the air therein migrates outwardly to and in the downstream direction along the inside wall of the tube,
c) an annular collection chamber defined in the downstream end of the tube and having an annular upstream opening coincident with the inside wall of the tube such that liquid flowing along the inside of the tube toward the downstream end thereof flows directly into the collection chamber,
d) an annular flow restrictor positioned at the upstream opening of the collection chamber and sized for free flow of liquid along the inside wall of the tube into the chamber and for blocking back-flow out of the chamber,
e) a drain hole positioned near the downstream end of the collection chamber, and
f) a flow interrupter projecting into the collection chamber to direct the liquid therein into the drain.

2. The separator of claim 1 in which the flow restrictor is sized to provide radial clearance with the inside cylindrical wall of the tube of between approximately one-fourth (¼) to one-half (½) inch.

3. The separator of claim 1 in which the flow restrictor diverges conically in the downstream direction to define a converging entrance to the chamber.

4. The separator of claim 1 in which the flow interrupter includes a first portion that projects generally radially from and extends longitudinally along the inside wall of the tube.

5. The separator of claim 4 in which the flow interrupter further includes a second portion that extends substantially circumferentially from the first portion.

6. The separator of claim 1 in which the flow interrupter is connected to project from downstream of the drain with respect to the swirling flow of liquid in the collection chamber to a position generally radially inwardly of the drain.

7. The separator of claim 1 in which the vanes (i) are provided with leading edges set at an angle of approximately 25 degrees with respect to the inlet opening, and (ii) extend substantially longitudinally therefrom at an angle of approximately 35 degrees and for longitudinal distance of approximately four and one-half (4-½) inches.

8. A separator for a mist collection system comprising:
a) inlet and exit couplings provided with inlet and exit openings, respectively, to allow air to be drawn therethrough,
b) upstream and downstream annular walls extending outwardly from the inlet and exit couplings proximate the inlet and exit openings, respectively,
c) an outer cylindrical tube connected between the upstream and downstream annular walls coaxial with and located radially outwardly of the inlet and exit openings to define (i) an upstream expansion chamber into which the air flow enters upon flowing through the inlet opening and (ii) a centrally located, open separation chamber downstream of the expansion chamber,
d) a set of stationary vanes fixed in the expansion chamber and sized and positioned to direct the air flowing therethrough in a cyclonic path into the separation chamber such that mist in the air therein migrates radially outwardly to and in the downstream direction along the inside wall of the outer tube,
e) an inner cylindrical tube extending forwardly from the downstream annular wall radially inwardly of the outer tube portion, the inner tube cooperating with the outer tube and the downstream wall to define an annular dead-ended collection chamber bounded therebetween and having an upstream annular opening coincident with the inside wall of the outer tube into the separation chamber such that liquid flowing toward the downstream end along the inside wall of the outer tube flows directly into the collection chamber,
f) an annular flow restrictor extending outwardly from the upstream end portion of the inside tube to define a converging flow path entrance into the collection chamber, and
g) a drain hole positioned near the downstream end of the collection chamber for discharging the liquid collected in the chamber.

9. The separator of claim 8 in which the flow restrictor is sized to provide radial clearance with the inside wall of the outer tube of between approximately one-fourth (¼) to one-half (½) inch.

10. The separator of claim 8 in which the flow restrictor diverges conically outwardly in the downstream direction.

11. The separator of claim 8 in which the vanes (i) are provided with leading edges set at an angle of approximately 25 degrees with respect to the inlet opening, and (ii) extend substantially longitudinally therefrom at an angle of approximately 35 degrees and for longitudinal distance of approximately four and one-half (4-½) inches.

12. The separator of claim 8 further comprising a flow interrupter positioned in the collection chamber to direct liquid therein into the drain.

13. The separator of claim 12 in which the flow interrupter extends longitudinally along the downstream end portion of the collection chamber.

14. The separator of claim 12 in which the flow interrupter is connected to extend from downstream of the drain with respect to the swirling flow of liquid in the collection chamber to a position generally radially inwardly of the drain hole.

15. A mist collection system for machine-tool liquids comprising:
a) an inlet,
b) an outlet,
c) a fan to draw mist-contaminated air through the inlet and to discharge the air through the outlet,
d) a cyclonic mist separator connected between the inlet and the outlet such that mist-contaminated air is drawn therethrough by the fan, the separator having
(1) an inside cylindrical wall through which the air flows,
(2) a set of stationary vanes positioned in the upstream portion of the cylindrical wall, the vanes being sized and positioned to direct the air flowing therethrough in a cyclonic path such that mist therein migrates outwardly to and flows downstream along the cylindrical wall,
(3) a collection chamber extending coincident from the cylindrical wall such that liquid flowing toward the downstream end of the cylindrical wall flows into the collection chamber,
(4) a flow restrictor positioned at the inlet of the collection chamber, the flow restrictor being sized for free flow of liquid along the cylindrical wall into the chamber and for blocking out-flow from the chamber,
(5) a drain hole positioned in the collection chamber for discharging the liquid therefrom, and
(6) a flow interrupter projecting into the collection chamber direct the liquid therein into the drain hole such that the separator pre-cleans mist from the air, and
e) a final mist-cleaning station downstream of the cyclonic mist separator through which the pre-cleaned air flows for final cleaning.

16. The mist collection system of claim 15 in which the flow restrictor is sized to provide radial clearance with the cylindrical wall of between approximately one-fourth (¼) to one-half (½) inch.

17. The separator of claim 16 in which the flow restrictor diverges conically in the downstream direction.

18. The separator of claim 15 in which the flow interrupter is connected to project from downstream of the drain with respect to the swirling flow of liquid in the collection chamber to a position generally inwardly of the drain.

19. The separator of claim 15 in which the vanes (i) are provided with leading edges set at an angle of approximately 25 degrees with respect to the inlet opening, and (ii) extend substantially longitudinally therefrom at an angle of approximately 35 degrees and for longitudinal distance of approximately four and one-half (4-½) inches.
